(19) United States
(12) Patent Application Publication
(10) Pub. No.: US 2003/0105638 A1
(43) Pub. Date: Jun. 5, 2003

(54) Method and system for creating computer-understandable structured medical data from natural language reports

(76) Inventor: Rick K. Taira, Newcastle, WA (US)

Correspondence Address: DORSEY & WHITNEY LLP, INTELLECTUAL PROPERTY DEPARTMENT, SUITE 3400, 1420 FIFTH AVENUE, SEATTLE, WA, 98101, US

(21) Appl. No.: 09/996,522

(22) Filed: Nov. 27, 2001

(51) Int. Cl. G10L 21/00

(52) U.S. Cl. 704/275

(57) ABSTRACT

A natural language translation method and system translating medical reports created in natural language into structured data frames that can be utilized in computer databases for decision support, billing, research, and other purposes. Structured data entry is elicited from a patient in order to identify an appropriate disease signature corresponding to his or her condition and symptoms. In turn, the disease signature identifies the appropriate lexical domain with which to analyze the natural language report. The translation method and system use statistical analysis based on empirical data that particular combinations of words have interdepended previously within a modeled context and how frequently individual words interdepend generally and with what kinds of words. For each sentence in the report, the words in the medical report are looked up in the lexical domain individually and in combination with all other words coexisting in the same sentence. The word combinations are parsed to determine the likelihood the words interdepend in the report. For those words determined to interdepend, a semantic interpreter defines the semantic relationship between the words. A frame generator compiles the word relationships into records having fields recognized as pertinent by the disease signature and that can be searched and sorted by computers on those fields.

### TECHNICAL FIELD

The present invention is directed to the generation of computer-understandable structured medical reports from natural language reports. More particularly, the present invention is a method and system that collects information directly from a patient in a structured format to isolate a relevant disease signature matching the patient's reported condition, and uses that structured information to support a statistically-based translation of an unstructured, natural language examination report from a medical professional into meaningful computer-understandable structured data frames.

### BACKGROUND OF THE INVENTION

The success of medical research, education, and, most importantly, patient care, has become increasingly dependent on the effective management of information. Our population is growing at an ever-increasing rate, people are living longer than ever before, new data-intensive diagnostic tools have proliferated throughout the medical community, and computer technology makes it more feasible to store large amounts of information on individual patients. As a result, the aggregate amount of patient information accumulating within the health-care system has become immense.

This tremendous body of information on each and every patient could be put to great use in developing a complete medical history for each patient that could aid in diagnosing present conditions, and possibly could be used to forecast or prevent future problems. Collectively, this body of information could benefit medical science and medical education as a whole in identifying trends in diseases and treatments, and in better training new medical professionals.

Unfortunately, while this information exists, so far it has proven to be practically impossible to manage effectively. The information can be collected and retained, but there is not an effective way to store the information so that it can be meaningfully accessed. This is because most reports generated by medical professionals that describe their patients' conditions and the effectiveness of courses of treatment do not adhere to any consistent format or structure. While the medical profession as a whole recognizes the importance of documenting their patients' case histories, the profession does not adhere to any particular convention, style or vocabulary in creating these reports. Consequently, while potentially valuable information accumulates, it is difficult to retrieve reports by information content.

If this body of information could be stored in a structured, coded fashion, it could be very, very useful because computers manage structured, coded information so effectively. The potential advantages of having a structured medical record are clear on at least three different levels. First, at the level of an individual medical report generated by a medical professional as a result of a single patient examination, having structured information can be used for decision support. The computer could analyze the structured record to generate a list of treatment options and/or to verify the method of treatment selected conforms to the current medical state-of-the-art. In addition, the computer could automatically flag certain potentially dangerous conditions indicated by the patient's data within the structured report, even when these conditions may not have been apparent to the treating professional. The computer system also could identify key image slices gathered through various medical imaging technologies based on references in the report text that will be useful for further diagnosis and treatment. Also, the computer would be able to automatically code or assist in the coding of the report findings and conclusions for entry into a medical database.

Second, at the patient record level, structured information would be beneficial in many respects. As a matter of course, the computer would be able to effectively organize the electronic medical record (EMR) for the patient, and thereby better present that patient's medical history. In addition, the structured record could assist in the management of the patient's diseases. From the structured data the computer would be able to generate a problem-centric timeline as well as present in a linear fashion all the relevant treatment that was provided. Also, the medical professional would be much better able to select how he or she wanted to have the patient's history presented for a given study.

Third, and perhaps most strikingly, structured data can tremendously advance medical science and patient care at the level of the entire patient population. Medical researchers would be able to access how all similarly presented patients were treated, and be able to review the outcomes of various types of treatment to help reach a more informed decision among alternatives available. Trends in such data could identify the better of competing courses of treatment, as well as to identify new modes of treatment which might not have been evident without the accumulated data. In addition, health-care providers would be better able to study the cost-effectiveness of various treatment regimens.

For these reasons, there is a tremendous need in medical reporting to utilize structured data entry methods so that knowledge contained within the medical record is, at least in part, structured and computer-understandable. In fact, federal regulation mandates the use of structured reporting in mammography, using a published lexicon of controlled terms. Clearly, the trend toward structured data is increasing as the medical profession continues to appreciate the value of such reports.

Even with the growing need for structured medical reports, most medical information still is created in an unstructured form. In attempting to keep up with patient demand, it is difficult for health-care professionals to document patient information at all; it is too burdensome of a task to expect medical professionals to document patient information in a particular closely defined structure to make it suitable for computerization.

A number of computer programs presently exist which were created to aid medical professionals in creating structured medical reports. Unfortunately, these computer programs do not simplify the chore of documenting the information for medical professionals. In fact, these systems make it even more burdensome for medical professionals to document patient histories. These programs require more time of medical professionals because they require medical professionals to enter data in a way which is foreign to them in a tightly restricted way, and the task becomes a very difficult one. Surely, the least desirable feature of any patient record-keeping system is requiring the medical professional to spend more time documenting cases rather than working with patients; an objective of any such system would be improving health care and reducing its cost, and not in adding even more administrative overhead.

Existing structured reporting programs are cumbersome because they afford medical professionals no latitude whatsoever in creating the reports. These existing systems require medical professionals to create reports through the use of a limited, pre-defined vocabulary, presented to them through the use of forms, templates, and/or macros. In effect, the medical professional is continually presented with a series of lists which define the possible choices he or she can make to describe the patient's condition.

As one would expect, these confining lists of choices present a number of significant problems. These systems create reporting bias as a result of the tendency of the reporting medical professional to try to fit his or her diagnosis into a predefined category. As a result of this reporting bias, the medical professional might misdirect the diagnosis by following unyielding report templates. Similarly these systems encourage some reporting neglect; the structured choices available to the medical professional tend to dissuade the medical professional from reporting unusual conditions, reporting of which might be highly useful to medical researchers in identifying side-effects of treatment methods or in improving patient care. These systems might further obscure the accuracy of the report because they do not permit a thorough vocabulary and grammar with which to describe all conditions. In addition, these systems may require every medical professional to describe every condition for every patient, even though the patient's own electronic medical record (“EMR”) may already include all the details pertaining to the patient's situation and condition. As a result of these shortcomings, use of these systems is time-consuming for the medical professionals, it requires the medical professional to alter his or her behavior. The resulting reports are likely to be, at best, grammatically incorrect or unclear. At worst, these reports will be non-specific to professionals consulting these reports in the future, and perhaps even completely inaccurate.

There are some systems under development today that generate structured reports while allowing medical professionals to type or dictate their reports as they normally would—in natural language. These systems, unfortunately, also have their shortcomings. These systems under development have not been widely deployed in clinical environments because the accuracy and workability of these systems are somewhat dubious. The problems with these systems stem from their underlying technological basis, which rests on a symbolic, rule-driven natural language translation system.

Generally, these systems tend to have significant problems when the reporter omits words or unusual syntactic structures. This is because these systems are based on manually-written syntactic rules that expect a certain type of word ordering within the text. These fragile rule-based systems are highly vulnerable to mistakes when a word is omitted, extra words are added, or a phrase is presented in an unusual manner even if it is perfectly complete and coherent.

In particular, there are three types of problems with such systems. First, it is virtually impossible for someone to completely model natural language using solely a rule-based system. The rules will never be exhaustive because of the infinite combinations and sequences that can be used to communicate a single thought. Moreover, most rules are not absolute nor independent, and multiple overlapping rules tend to interact very poorly.

Second, attempting to maximize the comprehensiveness of a set of rules often results in manifest ambiguity. Every time a rule is modified and extended to cover different and possibly obscure cases, it often leads to unforeseen errors. In other words, for every peripheral case or exception a rule is modified to anticipate, an unforeseen choice of phrase will fit that rule yet will yield a nonsensical result.

Finally it is very time-consuming and difficult to try to manage the rule base in a symbolic system. For every new context, not only do new terms have to be added to the lexicon of the system, but frequently entirely new set of rules must be created to define their interaction in that context. Similarly as more and more users work with the system, empirically, more and more rule sets will need to be created to allow for the correct translation of their different styles in phrasing.

What is needed is a system that can generate meaningful, accurate structured, computer-understandable medical reports that eliminates all or most of these problems. The system must be able to accept a medical professional's natural language report to avoid wasting that professional's time in following the strictures of an abstruse reporting system. The system must be able to respond to that natural language report even if the syntax and grammar used by the reporter are less than perfect. Further, the system must be flexible enough to account for unanticipated or unusual syntax as the result of the medical professional's unusual syntax or unexpected patient symptoms. It is to these needs that the present invention is directed.

### SUMMARY OF THE INVENTION

The present invention generates structured medical reports from natural language reports created by medical professionals by gathering data from patients directly, using a structured data entry approach, to isolate the appropriate disease signature. Isolating the disease signature focuses the natural language translation system on the proper lexicon of medical terminology and a set of algorithms tailored to translating natural language used in that field of medical specialization. Second, instead of a symbolic, rule-driven natural language system which analyzes words according to semantic and syntactic word patterns, the invention uses statistical natural language processing to analyze individual words and combinations of words to generate more accurate translations and to be more adaptable to different styles of phrasing.

### BRIEF DESCRIPTION OF THE DRAWINGS

FIG. 1 is a flowchart depicting the overall process employed in an embodiment of the present invention.

FIG. 2 is a sample introductory patient identification and ailment description screen from the patient data input phase.

FIG. 3 is a first miscellaneous symptom identification screen from the patient data input phase.

FIG. 4 is a second miscellaneous symptom identification screen from the patient data input phase.

FIG. 5 is a third miscellaneous symptom identification screen from the patient data input phase.

FIG. 6 is a flowchart depicting an overview of the natural language processing phase.

FIG. 7 is a flowchart depicting the operation of the lexical analyzer.

FIG. 8 is a flowchart depicting the process for gathering the knowledge required by the lexical analyzer.

FIG. 9A shows a first sample sentence from a hypothetical post-examination thoracic radiology report showing dependency relationships between the words in the sentence.

FIG. 9B shows a the resulting logical relations extracted from the sample sentence in FIG. 9A.

FIG. 10A shows the input and output characteristics of a generic logical relation classifier.

FIG. 10B shows the functional form of the maximum entropy probability distribution model.

FIG. 10C shows examples of feature functions supporting positive and negative evidence of word relationships.

FIG. 11A shows a phase space map showing the possible solution space for all possible logical relations in an sample sentence

FIG. 11B shows the link matrix showing sample, hypothetical link probabilities of specific word-word pairs.

FIG. 12 shows a partial type abstraction hierarchy illustrating how a concept such as “mass” can be semantically relaxed to a more general abstract class such as “physobj.abnormal.finding.lesion” to encompass a greater number of terms.

FIG. 13 is a flowchart depicting the operation of the parser/semantic interpreter module.

FIG. 14 is a sample screen used in a preferred embodiment of the invention allowing the reporting medical professional to review and correct, if necessary, the structured data derived from the natural language report.

FIG. 15 is a sample frame generated for the sentence shown in FIG. 9A.

### DETAILED DESCRIPTION OF THE INVENTION

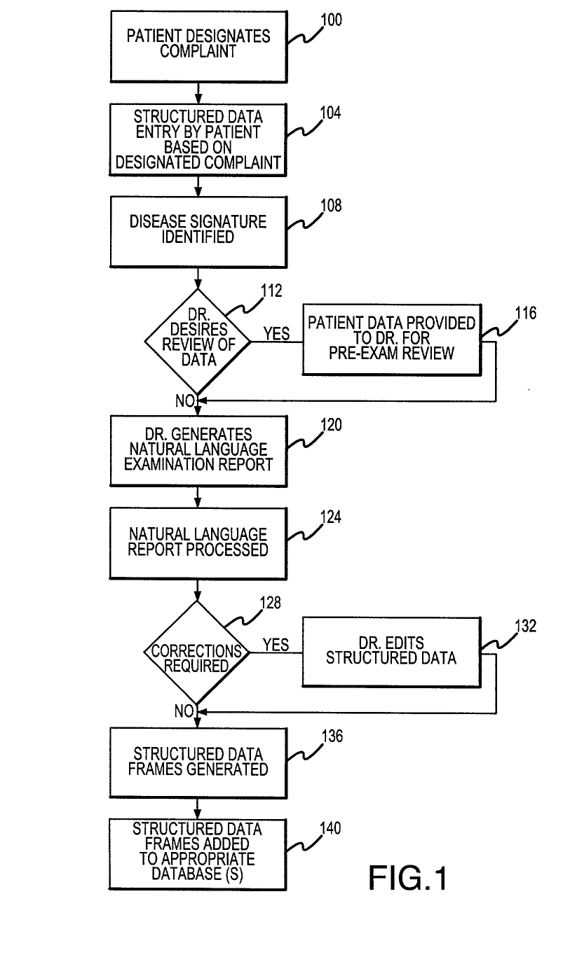

FIG. 1 overviews the operation of an embodiment of the present invention. In general, the process begins with each patient taking part in structured data entry to communicate information about his or her illness. First, the patient begins by specifying, generally, what is his or her complaint at step 100. Keying off that initial complaint provided by the patient, the system then presents the patient with a series of questions related to that complaint at step 104. Based on the information identified by the patient, and refined by successive, structured queries posed to the patient, at step 108 the system identifies the appropriate disease signature. Identification of the appropriate disease signature allows the system to select and use the appropriate disease lexicon for further processing. At step 112, if the examining medical professional desires and/or circumstances permit, the data gathered from the patient and the disease signature identified will be relayed to the medical professional at step 116.

Subsequently, after the patient has been examined and the medical professional has reviewed the results of any indicated tests, the medical professional generates a natural language examination report at step 120. This report may be typed, dictated to tape then transcribed by an assistant, or generated with known speech recognition programs. The natural language report so created is then submitted for natural language processing at step 124. The natural language processor determines the relationships between the words and phrases in the report, based on the disease signature determined from the patient's structured data entry, through the operation of the parser/semantic interpreter to be described in detail below. Once those relationships have been identified, at step 128 the medical professional has the opportunity to review the structured data derived from the natural language report and, if necessary, correct or revise the structured data at step 132. The structured data is then used to generate structured, computer understandable data frames at step 136. The frames are then stored at step 140 in appropriate databases where they can be studied at the procedure, patient, or patient population level. Once stored, the frames can be evaluated to detect medical conditions, evaluated for decision support of proper treatment, used for patient and health insurance billing, and other purposes.

The structured data entry of steps 100 and 104 can be carried out in a number of ways. Patients with Internet access might undertake this dialog in front of a computer in their homes, or wherever else they can access the Internet, hours or days before their visit to the physician. Alternatively, patients could be asked to undertake this data entry at a computer located in the medical facilities upon their arrival at those facilities. Patients could also be given wireless tablets or other devices with which to enter data concerning their illnesses. Other means also can be used to gather patients' data.

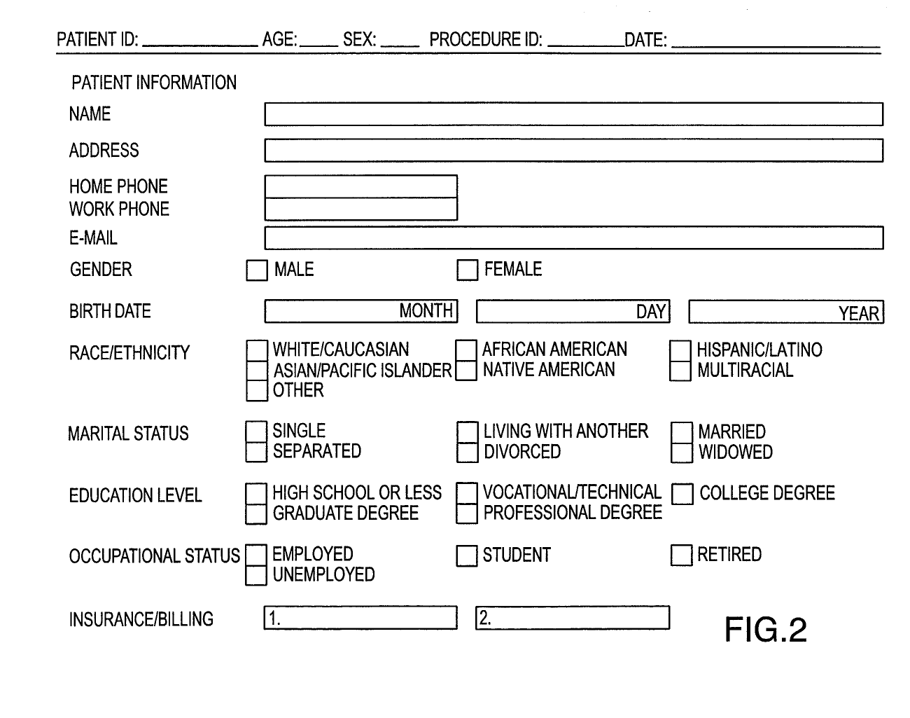

FIG. 2 is a sample introductory screen with which the patient might initially be presented. Naturally, the patient needs to identify himself or herself with his or her name, address, and similar information. Demographic information which may or may not prove useful in furthering the examination process also can be collected, considering that the likelihood of certain illnesses affecting people can change with gender, race, age, and situational or occupational conditions. Certainly, to further expedite the process, billing information also may be solicited here. If the data entry device is connected to a database already containing some or all of this information, the known information could be transferred to this new patient record, and the patient would not need to re-key the known information.

Once the initial introductory information has been collected, the patient then will be asked about his or her symptoms. The patient may be prompted very generally for their reasons for visiting the doctor, such as whether the visit is merely a routine check-up, a first visit with regard to a new ailment, or one or a number of continuing visits concerning a previously examined condition. The patient may be asked, if he or she knows it possibly because the visit relates to an ongoing condition, to select the condition from a common list of ailments associated mainly with anatomic region. This selection activates an automatic look-up of the code corresponding to the International Classification of Diseases, version 9 (“ICD-9”) system, or in a later version of that classification system. If the patient has visited this medical center before, or has been referred by another facility, once the patient's identity has been entered, the system might prompt the patient from a list of previously reported ailments. From this selection, the system will automatically look up the corresponding ICD-9 code.

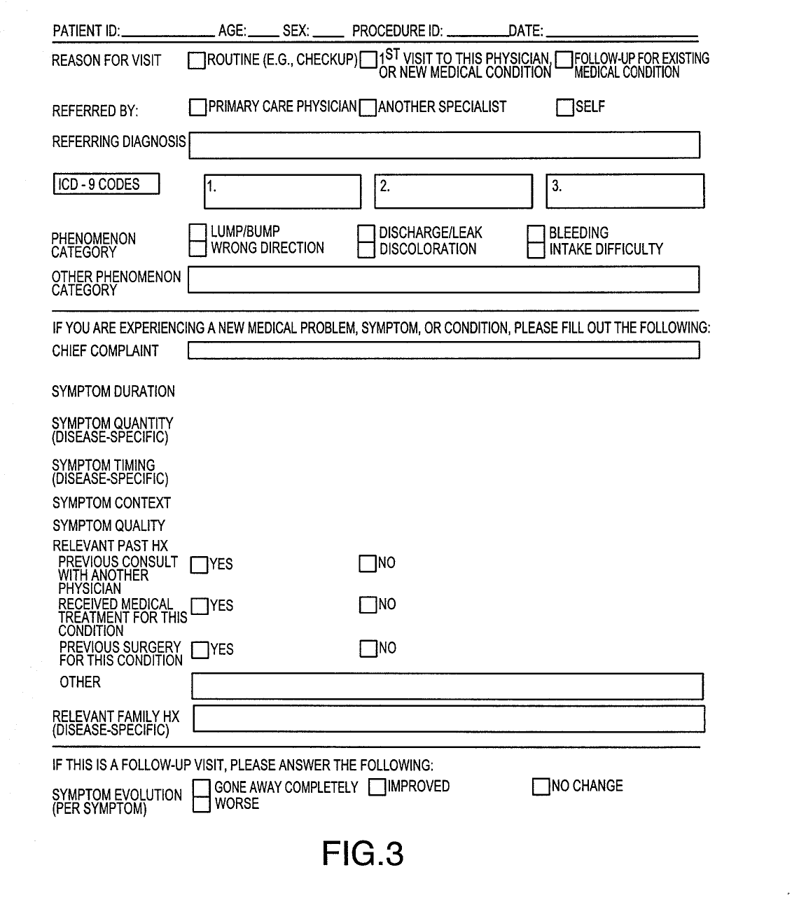

Responding to the initial information provided by the patient, the patient might then be provided with a series of data entry screens tailored to gather information relative to the reason for the visit. For example, as shown in FIG. 3, if the reason for the visit regards a new ailment, the patient might be asked about his or her symptoms, such as what is his or her chief complaint, how acute and frequent the symptoms are, and related questions. With these symptoms identified, the system can then begin to identify the appropriate disease signature for the patient's ailment.

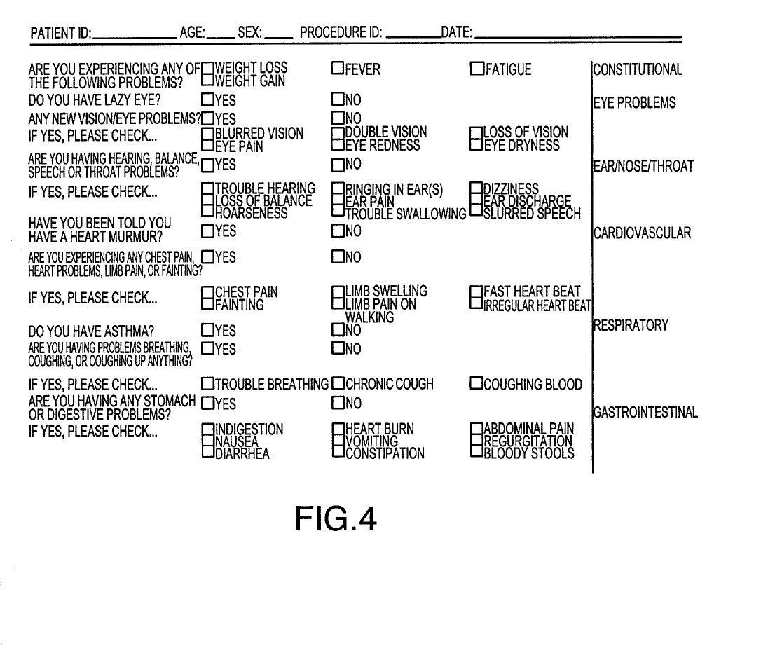

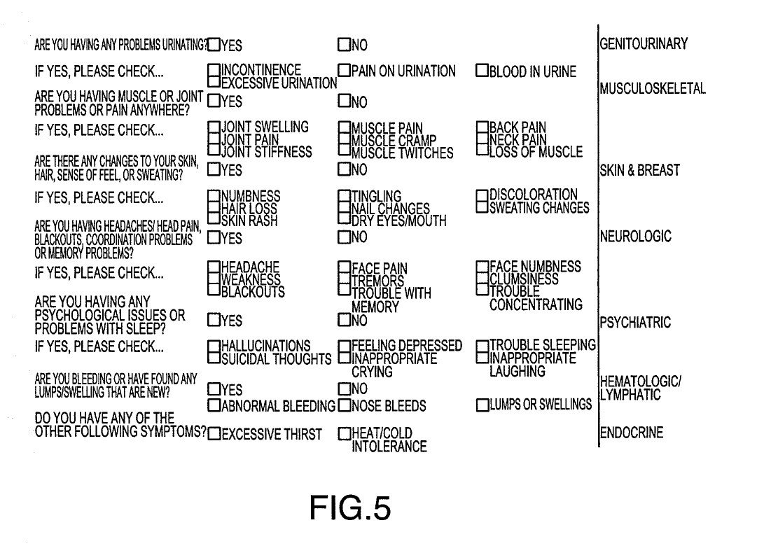

Keying off of the initial information solicited from the patient and/or to elicit a comprehensive body of information about the patient generally, the patient might be asked a battery of other questions as shown in FIGS. 4 and 5. Questions about recent weight loss or gain, difficulty or lack thereof in breathing, digestion, or elimination, changes in skin condition, appearance of joint pain, and other issues all might help the system isolate the patient's illness. Some of these questions might be standard questions asked of all patients, whereas some might be generated in specific response to the symptoms already identified by the patient or by the patient's history, if available to the system. Again, all information gathered will be used by the system in identifying the pertinent disease signature or disease signatures with which the system will analyze the natural language report provided by the medical professional later in the examination process.

Hopefully it will be appreciated with regard to FIGS. 2, 3, 4, and 5, that these data entry steps could be manifested in any number of forms. The data entry steps might be presented to the patient one field or one line at a time to make the system more user-friendly, or to better adapt the process to the type of data entry device that is available to the patient. The screens could be presented on a conventional device whereby the patients would enter their responses via a keyboard. Alternatively, on a suitably advanced wireless tablet device, the patient might be able to hand-write their responses and the system would be able to translate their handwriting utilizing the same technology that is well-known for presently available handheld devices. Speech recognition systems could be used for this purpose, as well.

In the initial steps 100 and 104, some of the burden of generating a meaningful structured report is shifted to the patient by having the patient take part in structured data entry to articulate the nature of his or her illness. Three benefits result from having patients participate in this structured data entry step. First, because patients are many and doctors are few, and structured data entry is time-consuming, having the patient perform the structured data entry relieves medical professionals of that time-consuming chore. It should be noted that it is important for this to be structured data entry. Although part of the significance of this embodiment of the present invention is that it generates meaningful structured reports regardless of the medical professional's style and choice of vocabulary, medical professionals nonetheless can be counted on for some consistency within a range of vocabulary by virtue of their training. A number of patients all suffering from the same illness, on the other hand, each might conceive of an entirely different and potentially novel description of their ailment, making it impossible or difficult for any natural language system to determine even the general nature of their malady.

Second, a synergistic benefit of this process is getting patients more involved in their own course of treatment. Even this reasonably simple process of having patients sit and consider their symptoms and other physiological condition cannot help but give the patients a sense of participation in their treatment, giving them a sense that they, too, are involved in curing what ails them.

Third, the important outcome of these steps is the isolation of an appropriate disease signature at step 108 of FIG. 1, the significance of which will become more clear later in this detailed description. By generally identifying what is the ailment, the system can better determine where the examination will lead and, more pertinently, what the reporting medical professional will address in his or her natural language report. For one example, if the patient has been having chest pain, the structured data entry sequence can then direct the patient to more questions about the nature, location, recency, frequency, and other aspects of the pain. In such a case, the problem could be heart disease, it could be heartburn, or it could be something else entirely. Nonetheless, in the later phases of the process, the natural language processor will be expecting terminology regarding these symptoms and possible diseases. By expecting these terms, as will be further discussed with regard to the training and operation of the system, the system can much more effectively and efficiently interpret the medical professional's report in generating the resulting structured data.

With regard to FIG. 1, Step 112 is a conditional step responsive to the medical professional's choice or schedule. Some medical professionals surely prefer to talk to their patients directly to hear what are their symptoms. Alternatively, some medical professionals may prefer, particularly if the patient has undertaken the structured data entry steps 100 and 104 in advance of visiting the medical facility, to review a report or summary of the information gathered from the patient to help them prepare for meeting the patient and conducting the examination. If the medical professional wants to view a report or a summary, the system will provide it to him or her at step 116. On the other hand, if time does not permit or the medical professional prefers not to review this information, the medical professional can proceed directly with the examination.

At the conclusion of the examination, the medical professional will generate his or her report on the patient at step 120. Most medical professionals already undertake this step as a matter of sound practice to document a patient's file to substantiate a course of treatment, as well as for use in future treatment of the patient. One of the advantages of the present invention is that the medical professional need not make any changes in the way he or she creates these reports to use the invention to generate structured medical reports. If the medical professional currently types his or her examination reports, he can utilize the present invention. If he or she dictates the examination reports and has them transcribed, he or she can continue to do the same. If he or she dictates the examination reports to a speech recognition system, he or she can continue to do the same. All of these can be used to submit a natural language examination report to the present invention for the generation of a structured medical report.

If the medical professional dictates his or her reports, those reports can be translated to a computerized form using any of the number of speech recognition programs currently available. If the medical professional dictates those reports to tape, he or she can have those tapes played to a speech recognition system or, alternately, may choose to start dictating to a speech recognition system. In either event, the speech recognition program will generate a computerized text version of the dictated report. The computerized text generated is the grist which is processed in light of the disease signature developed from the patient's structured data entry. On the other hand, if the medical professional types his or her reports on a computer, or prefers to dictate them to tape and have them transcribed on a computer, then computerized text also will be created which can be submitted to the natural language processing phase.

At step 124, the examination report is submitted to the natural language processor. As previously described, the computerized text of natural language reports can be created in any number of ways. With the disclosed embodiment, it is simply a matter of submitting the text generated to the natural language processor to generate the structured data.

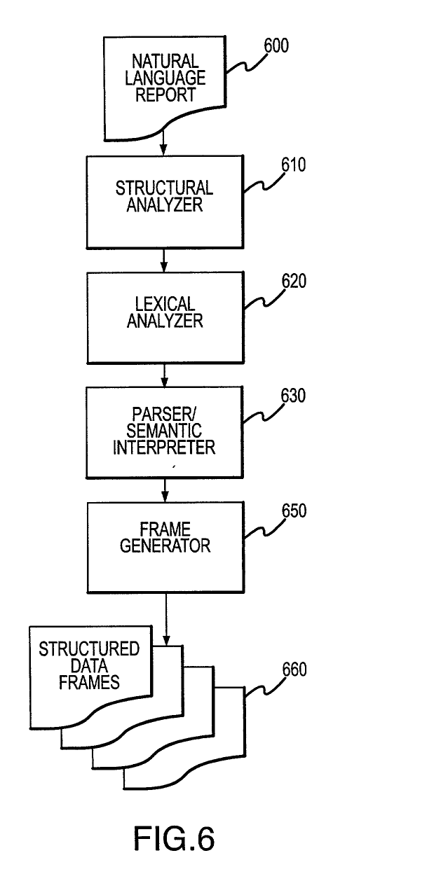

FIG. 6 further details the steps inherent in the natural language processing of the examination report. It must be noted that these steps are the steps undertaken by the present embodiment; these are not steps which the medical professional or support staff must perform individually. When the medical professional or the person responsible for submitting the natural language reports 600 to the present embodiment of the invention enters the reports into the system, these steps will be performed automatically.

Referring to FIG. 6, the first step is conducted by the structural analyzer 610. Structural analysis can be performed by a variety of known methods, and, generally, consists of dividing the natural language report into sections and sentences. At the section level, the structural analyzer divides the report into “Procedure Description,” “History,” “Technique”, “Findings,” “Impressions,” etc. At the sentence level, the structural analyzer divides the text within each section into individual sentences.

The first step undertaken by the structural analyzer is the identification of the section boundaries within the report text. In a preferred embodiment, the algorithm for section boundary detection is conducted in two passes. The first pass algorithm is a high-precision rule-based algorithm that detects the start of each new section of the report. The algorithm is programmed to recognize that, if a section start delimiter is found, then it is highly probable to be a true section start delimiter. The first pass algorithm uses a knowledge base of commonly employed heading labels and linguistic cues that signal the start of new sections, such as colons, phrases expressed in all capital letters, abbreviated lines, and/or sentence fragments, which have been noted within training examples for the report under analysis. For example, radiology reports typically include the heading labels “Procedure Description,” “Date,” “Clinical History,” “Reason for Request,” “Findings,” and “Impressions”; these fragments would be recognized by the algorithm as denoting the start of a new section.

On the other hand, it is not uncommon for a medical report not to include heading labels. Accordingly, the second pass algorithm detects the section boundaries by using a probabilistic classifier. This probabilistic classifier is based on an expectation model derived from the document structure of classes of medical reports typically used in that particular specialty. The class of medical reports is defined by the institute, the department, and the encounter description, for example, “UCLA Medical Center,” “Radiology,” and “Thoracic CT scan,” respectively. The expectation model of the classes of medical reports is created during system development. The expectation model includes statistics reflecting the typical order of sections within a particular class of reports, the typical number of words employed within a particular type of section, and the typical types of substantive communications expressed within each particular type of sections. A type of substantive communication indicative of a section, for example, is that a “Conclusion” section usually includes the types of medical findings, and their possible etiologies. Simple statistical calculations, such as mean and standard deviation calculations, and t-tests are used to determine the probabilities as to section boundary locations.

The second step in the structural analysis phase is the identification of the sentence boundaries within each section of the report text. The algorithm for determining sentence boundaries uses a maximum entropy classifier similar to that discussed by A Ratnaparkhi in his Ph.D. dissertation “Maximum Entropy Models for Natural Language Ambiguity Resolution,” in the Computer Science Department at the University of Pennsylvania in 1998, incorporated herein by reference. In total, the classifier uses some 44 overlapping features to determine whether a period corresponds to an end of sentence marker or not. The system has a rate of accuracy of 99.8% in differentiating between periods used within the context of end of sentence markers, decimal points in numeric measurements, parts of enumerations, and parts of abbreviations.

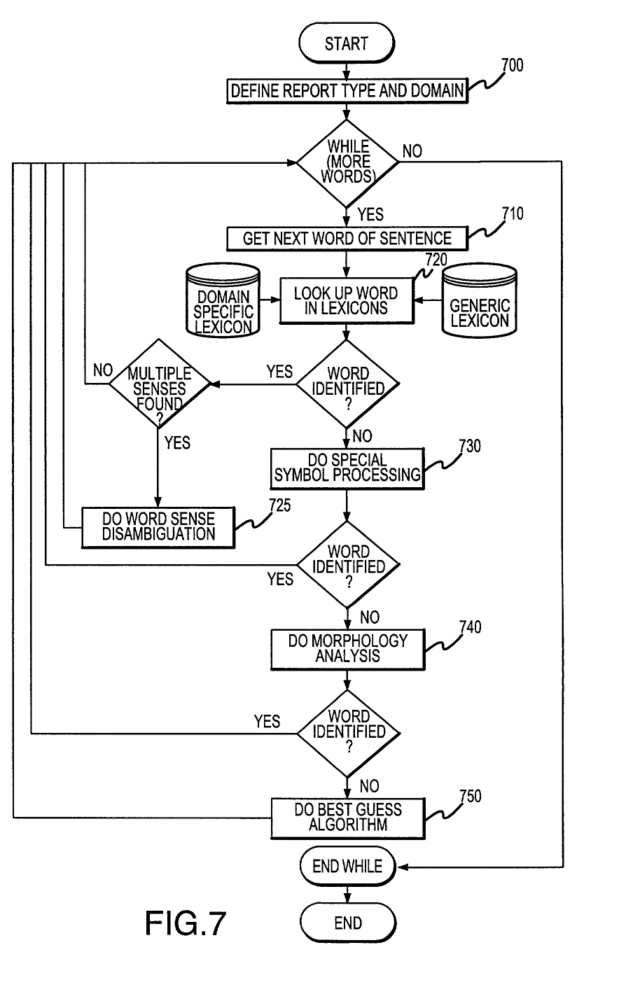

Once the natural language report has been structurally analyzed and divided into constituent sentence blocks, each of those blocks relevant to the illness, its diagnosis, and treatment, are processed by the lexical analyzer at step 620. The operation of the lexical analyzer is described in detail in FIG. 7.

With reference to FIG. 7, the lexical analysis of each sentence begins at step 700 with defining the type of report and domain from which the sentence was extracted. The structured data entered by the patient and information on the reporting professional, the disease signature previously identified by the system, are used in identifying the domain. The type of report is defined by the type of encounter, such as an examination in “radiology.” The type of domain is defined by the medical subspecialty often related to anatomy, for example, “pulmonary medicine.” The system uses this information to clarify the interpretation of each word within its intended context. At 710, for each sentence the system sequentially evaluates each successive word of the sentence, starting from the beginning, until all words have been processed. The first processing step occurs at 720, where words are simply looked up within the system's lexicon. The lexicon is the database of the system's lexical knowledge, and provides the syntactic class and semantic class of each word sense. In a preferred embodiment, the lexicon contains over 10,000 word entries, and recognizes over 250 semantic classes and 14 syntactic classes.

Each word appearing in the lexicon is characterized by a concept identifier and their corresponding syntactic and semantic classes. Words that have multiple senses have multiple entries in the lexicon. (For example, the word “discharge” can be a noun as in “a discharge of pus” or a verb as in ‘the patient was discharged). There are currently over 250 semantic classes organized within hierarchical clusters. For example, the word mass is assigned the semantic class “physobj.abnormal.finding.lesion.solid.”

The disambiguator at 725 uses a number of statistical classifiers to resolve the meaning of a word that has multiple senses. For example, the word “density” may refer to a radiographic density that may refer to the presence of a mass, the darkness of a radiographic film, or the mass density related to the chemical composition of some matter. The statistical classifiers resolve word sense ambiguities using different types of knowledge stored about each word. One class of knowledge regards the part of speech for which the word appears. For example, the word “discharge” could be a noun, such as in “a discharge of fluid,” or a verb, such as in “We would like to discharge the patient tomorrow.” In this case the classifier uses the syntactic properties of surrounding words as features determine how the word is being used and, as a result, which channel's features from its lexicon entry will be applied in subsequent analysis of the word.

There are three different word sense disambiguation classifiers in a preferred embodiment, including “isWordANoun,” “isWordAVerb,” and “isWordAnAdjective.” These classifiers not only use syntactic knowledge of surrounding words but also semantic knowledge. In considering the surrounding words, the classifier examines, for example, what types of verbs are statistically associated with a particular sense of the word in question, what types of arguments are statistically associated with the verb sense of the words, and what types of adjectives are statistically associated with the noun sense of the word in question. For example, for the first sense of the word “density” referring to a radiographic finding of the presence of a mass, surrounding words that refer to its size and location, such as “large” or “upper right lobe,” respectively, provide sufficient context to eliminate the other potential senses of the word density.

If a word is not found in one of the system's lexicons, the system passes the word to a number of special symbol processors at step 730. These processors include date processors, special anatomy abbreviation recognizers, special disease coding recognizers, image slice reference recognizers, numeric measurement recognizers, and proper name recognizers. Special anatomy abbreviation recognizers would identify specialized designations such as “T1 spine.” Special disease coding recognizers identify predefined codes used in a specialty to identify certain specific characteristics, such as TNM staging codes for lung cancer. Image slice recognizers identify when a phrase refers to a term used locally in the context of the examination to refer to a particular slice from an imaging study, such as “slice 23-30, sequence 10 from an MR scan.” Numeric measurement recognizers identify quantitative descriptions of size, flow, or other qualities, such as “size of 3.0 by 4.0 by 5.4 centimeters,” “3 milliliter per second flow,” or “pressure 80 millimeters Hg.” Finally, proper name recognizers identify names of patients, referring or consulting physicians, and other names. These special symbol processors utilize finite state machines and regular expression operators to recognize alphanumeric character patterns associated with each special symbol type.

If the word is neither in the system's lexicons nor can be resolved by the special symbol processors at 730, at step 740 the word is subjected to a morphological analysis. Here, the system attempts to recognize any prefixes, suffixes, or Latin roots common in medicine. A simple rule-based system is used for then determining the syntactic and semantic category of the word. For example, words with a prefix of ‘itis’ are assigned the syntactic category of ‘noun’ and semantic category of “condition.abnormal.inflammation.”

Finally, at step 750, if the word still is not resolved, the system uses a best guess algorithm using the surrounding words as context. The best guess algorithm provides only a partial answer, determining only the part of speech of the word and not its semantic class. This step uses the same algorithm described in step 725 (i.e., “isNoun,” “isAdjective,” “isVerb”).

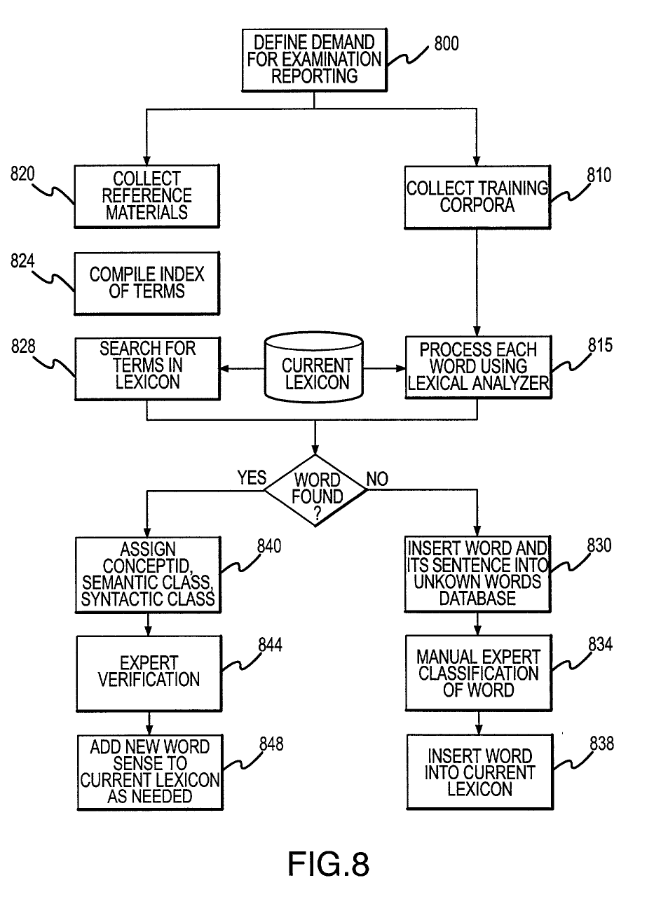

FIG. 8 depicts how the lexical analyzer's lexicons are created. At 800, the first step is defining the different domains used by the lexical analyzer. Each domain can be thought of as the appropriate reference volume for each disease signature identified by the patient's structured data entry. In other words, once the patient has provided sufficient information to the system to isolate what illness or possible illnesses for which he or she has presented for treatment, the lexical analyzer loads the appropriate volume of information that will be used in analyzing the language used in the medical professional's examination report. For example, if the patient provides information that indicates he or she has presented for continued treatment of a previously identified ailment, the lexical analyzer uses the database for that previously identified illness. Based on the identifying information provided in FIG. 2, coupled with the patient's declaration that he or she presents for treatment of an existing condition, the lexical analyzer can be directed to the appropriate database for that condition. On the other hand, if the patient is a new patient or presents for treatment of an illness for which he or she previously has not sought treatment, then the structured data entry phase of the present invention will question the patient until the system has identified, at least tentatively, the disease signature for the illness or illnesses the patient presents for treatment. Once the illness or illnesses have been identified, the system selects those databases for use by the lexical analyzer.

Natural language analysis based on an identified disease signature is a feature that contributes to the accuracy of its natural language processing. Different phrases can have different significances in different contexts. For example, the word “diaphragm” can refer to a part of the body or to a birth control device. Thus, whether a patient has presented complaining of shortness of breath or seeking means for birth control can help the system to better ascertain whether the medical professional in his or her report was detailing the illness or describing what he or she prescribed for the patient. Similarly, the word “increased” could refer to a prescribed treatment, such as a changed dosage of a medication, an expected and positive result, such as a change in the patient's lung capacity in response to treatment, or a negative symptom, such as a change in size of an abnormal mass in the body. Clearly, determination of the disease signature will help the natural language processor generate a correct result of the meaning of the medical professional's report.

Having defined a number of different domains to correspond to different contexts and, thus, different types of illnesses and fields of study, the next step in gathering knowledge required by the lexical analyzer is collecting test corpora to program the lexical analyzer domain databases at 810. Simply, test corpora are actual, natural language medical reports for the domain being programmed. Ideally, a range of different reports from different practitioners having different reporting styles will be collected to contribute to the creation of a suitably representative, encompassing body of reference.

Using this body of reports, human knowledge engineers who are familiar with medical terminology, taxonomy, and the extensive semantic classes employed by the system, classify unknown words and verify answers provided by the current working version of the lexical analyzer. The system's lexicons maintain both single-word and multiple-word phrase entries. Multiple-word phrase entries are useful when they represent a concept that cannot be precisely described using only the component words. A preferred embodiment does not use existing lexical sources, such as the National Library of Medicine's Unified Medical Language System (UMLS) Metathesaurus, for these sources do not support the level of knowledge or detail required for the preferred embodiment's system of natural language understanding. For example, these sources do not contain a sufficient number of semantic classes to support the statistical parsing and semantic interpretation algorithms used by the preferred embodiment. In addition, these sources frequently do not cover important descriptive adjectives common in medicine.

By contrast, words and word phrases to be included in the lexicon are gathered from two distinct sources. At step 820, information is collected from published sources including the indices of medical textbooks, review manuals, and other published medical glossaries. For example, in thoracic radiology, glossaries compiled by the Nomenclature Committee of the Fleischner Society are consulted. Incorporating designations used in these published sources ensures that the lexicon entries for each word or phrase properly reflect the range of generality for which the word or phrase might be used. From these sources, an index of terms is compiled at 824. Each of these terms is looked up in the lexicon at 828 to determine if that term is already entered in the lexicon.

On the other hand, drawing from these published sources still does not include all the potential different sequences of words or string representations that might be used to represent the same concepts. Therefore, the second source of terms to include in the lexicon are from the actual medical reports from a specific domain compiled at step 810. The collection of words and word phrases from actual reports ensures that the system works at a practical level, and that most of the string representations for the basic concepts prevalent in that domain are included. In a preferred embodiment, over 10,000 medical reports from each domain might be analyzed as part of this step. Words from actual reports also are looked up in the lexicon to determine if they already are entered in the lexicon.

Even for words found to be in the lexicon, some of these words are randomly selected to be verified by a human expert at 844. The expert reviews these sampled terms and verifies that the syntactic and semantic classification of the word is correct within the context of the sentence and/or medical domain. If it is incorrect, the expert can add a new sense of the word to the existing database of words at 848. If the word is not found, then the word is inserted into an “Unknown Words” database. Each word in the unknown words database is classified manually by a human expert then inserted into the database at 838.

In sum, a preferred embodiment of the lexical analyzer of the present invention yields a number of benefits. First, in recognizing more than 250 semantic classes, the number of semantic classes is extremely rich, especially when compared to lexical sources currently available. Recognizing such a large number of classes allows the output of the preferred embodiment of the invention to accurately model the expression of very specific conditions. Second, the preferred embodiment reliably recognizes special symbols within text including dates, medical abbreviations, medical coding symbols, numeric measurements, image slice references, and proper names. Third, for words not entered in the system's lexicon, the preferred embodiment uses knowledge of common medical prefixes, suffixes, and Latin roots to guess the meaning of unknown words. Fourth, also for words not entered in the system's lexicon, their syntactic categories are estimated based on surrounding grammar. Fifth, the preferred embodiment customizes the medical lexicon according to the type of examination and the disease signature for the condition for which the patient presents for evaluation and/or treatment. This information is used to disambiguate the meaning of a word or phrase from among various types of conditions. Sixth, the system uses statistical methods to resolve the meaning of a word that has multiple senses. Finally, the system employs a recursive algorithm, refining the characterization of words with each iteration. For example, the results of one iteration are sent to the next stage of processing, including parsing and semantic interpretation to be described below, and based on the results of this stage may trigger a refinement of a word's classification in the system's lexicon. This refinement occurs only for words that have multiple senses and/or that have no entry in the lexicon.

The results of the lexical analyzer provide the word level knowledge required for the subsequent stages of processing in the system. In the next stage, the preferred embodiment of the present invention combines the tasks of syntactic parsing and semantic interpretation into a single, integrated parser/semantic interpreter operation. This is in contrast to existing systems that first perform syntactic parsing followed by a separate semantic interpretation step. Parsing refers to determining a dependency between words, while semantic interpretation refers to determining the nature of the dependency; combining those steps more accurately and efficiently determines the existence and nature of the dependency of words within the sentence.

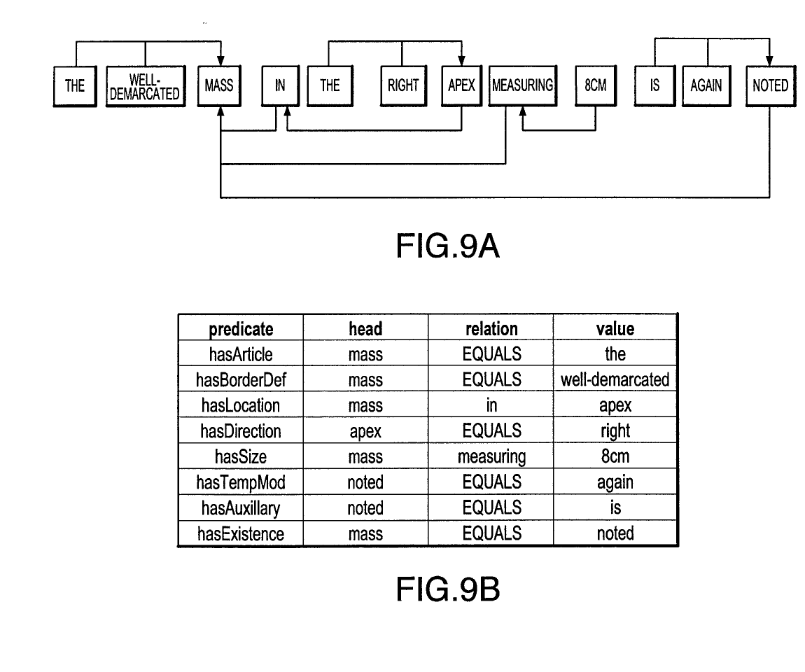

FIGS. 9A and 9B illustrate the concepts of the existence of word-word linkages and the nature of those linkages using the example sentence “The well-demarcated mass in the right apex measuring 8 cm is again seen.” FIG. 9A illustrates the resulting dependency diagram for this sentence in terms of binary “head-modifier” or dependency relationships between the words of the sentence. FIG. 9B shows the final output of this sentence by the combined parser/semantic interpreter stage of the preferred embodiment of the system. It consists of a collection of logical relations that are applied to each input sentence. A logical relation consists of a predicate (e.g., “hasLocation,” “hasSize”) and an ordered list of one or more arguments for these predicates. The predicate indicates the type of relationship between the arguments. In most cases, each logical relation consists of three arguments: a head, a relation, and a value. The head is the concept being modified by the value. Often a default of EQUALS is used for the relation.

The parser/semantic interpreter step of the preferred embodiment of the system can be seen as a low-level extractor of primitive level communications from the sentence outputting a context-independent representation. The logical relations are these primitive level communications, such as “hasLocation,” “hasSize,” “hasExistence,” that serve to normalize much of the alternative ways of expressing the same concept in free text. For example, the words in the expressions “a right apical mass” and “a mass in the right apex” are recognized by the preferred embodiment as having identical logical relations.

The preferred embodiment of the present invention uses a statistical database derived from published materials and extensive training corpora. This is in marked contrast with the parsers and semantic interpreters from conventional natural language processors are symbolic, rule-driven systems. In other systems, words are essentially passive products submitted to a conventional processor where they are categorized into a part of speech, then subjected sequentially to a number of fixed rules to determine what words modify or are modified by the words being analyzed. If the rules are not exhaustive—and for reasons previously discussed, practically the rules can never be exhaustive—errors will result when any unconventional phrase or construction is submitted. Along these same lines, the more complex a grammatical construction is used by the reporter submitted to the processor, the more likely the processor is to fail to find or to misapply a rule.

By contrast, the system employs statistical classifiers for parsing and semantic interpretation of a sentence. This approach allows the system to make a best guess decision based on partial and/or even conflicting evidence. This is due to the deployment of a single mathematical model that weights individual features for the task of making a single decision. There are typically several tens of features for each classifier. Thus, the statistical classifier is able to make some decision for new unseen contexts outside its training set. In contrast, a rule based system only fires when the entire rule is matched. For any context which does not have a corresponding rule, no decision can be made. In creating the knowledge base of the preferred embodiment's parser/semantic interpreter, the programmers study word-word interactions seen in sentences within training corpora. The study of word-word interactions to develop the knowledge base for the parser/semantic interpreter is approached in a very systematized fashion. Word-to-word attachments are treated as a particular phenomenon under study. In this case, for example, the phenomenon is the connection between a logical relation, such as “hasSize,” the value of the logical relation, such as “8 cm,” to its head, such as “mass.” Expression of these relations often is facilitated via an intervening relational word, such as “measuring.” The documentation being processed must include the relevant context or state information associated with this low-level communication. For instance, in the previous example of “hasSize,” “8 cm,” and “mass,” this information would be the expression of a mass size. From this documented behavior, theories can be proposed to explain the observed behavior in the text being processed.

The method followed in creating the knowledge base for the parser/semantic interpreter for each logical relation has five steps. The first step is problem formulation, in which specific phenomena are identified for investigation. The second step is data collection, in which a set of sample reports relevant to the phenomena being study is collected. The third step is creation of training data by taking the data collected in the second step and manually identifying the logical relations between the words in the sample data. The fourth step is the creation of a statistical model to account for the data by hypothesizing and refining a set of principles which account for the word patterns observed. The final step is the evaluation of the knowledge base by testing it against further sample reports. It will be appreciated that this is an iterative process, with successive iterations of these steps further refining the accuracy of the statistical model that is the knowledge base.

First, in the problem formulation step, all the relevant logical relations are identified between the words for each given sentence from a medical report. The ultimate goal then is to find all elementary relationships within a domain of study. For example, within a relatively focused domain such as thoracic radiology, there are approximately 120 different types of logical relations of interest to categorize the relations which might be reflected in a report. These relations, for example, include “hasSize” to connect size parameters with the body being described, as well as other relations such as “hasShape,” “hasInterpretation,” “hasExistence,” “has Article,” and “hasArchitecture.” The elementary set of logical relations form what are known as a “canonical basis set” used for encoding the knowledge extracted from medical sentences within a domain. The logical relations within this canonical basis set can be combined into more complex relations by applying a set of formation rules. For example, the phrase “The mass is 5 cm in long axis dimension” the logical relation “hasSize (“mass”, EQUALS, “5 cm”) is enhanced by the elaboration of the logical relation “hasDimension” (“5 cm”, EQUALS, “long axis dimension”). Here the value of the “hasSize” logical relation (5 cm) is the head of the “hasDimension” logical relation.

The actual approach is to build many highly specialized processors for the task of semantic interpretation. Each processor is programmed to identify a single elementary logical relation, such as “hasSize.” The task thus reduces to developing separate processors for each focused communicative topic, leading to a more accurate, flexible, manageable, evolutionary, and adaptable system. Each elementary processor is intended to fully operate under a wide variety of choices of words, phrases, and sentence structure to seek out and identify a single focused goal. The knowledge, whether lexical, grammatical, or pragmatic, required for each specific task can be encapsulated within these task specific processors.

Second, in the data collection step, the process is to gather a wealth of diverse, representative samples of medical reports to represent the types of reports which might be encountered as completely as possible. The performance of a statistical classifier depends on the interrelationship between sample sizes, number of features, and classifier complexity. In general, the greater the number of quality samples that can be obtained for training, the better the performance of the classifier. Sampling can be performed in a completely random fashion, or biased toward examples for which it is expected the classifier needs to be refined.

The first task in the data collection step is to gather a large number of representative reports from a given medical domain. In a preferred embodiment, five to ten thousand reports should be gathered for a given domain to provide a suitably diverse and rich cross-section of reports with which to build the knowledge base. The next step is to select a large set of both positive and counter-examples for each type of logical relation as seen within the test corpus of reports.

In the preferred embodiment, the optimal approach is to collect a set of random samples for a given logical relation using a sentence retrieval engine that maximizes “recall.” Recall is defined as the number of true-positive samples returned that truly correspond to an example of that relation, divided by the sum of the number of true-positive examples plus the number of false-negative examples, which are true-examples existing within the training corpus but not retrieved in this selection process. The retrieval engine allows queries to be expressed in terms of word order and lexical features of words. For example, for the “hasSize” classifier, the search engine could be asked to find example sentences that contain words with the semantic feature “spatial.size” (e.g., large, “5 cm”). Both true-positive (“5 cm mass”) and false-positive (“5 cm above the carina”) examples will be included in the retrieved samples. If a search engine is able to locate a large number of examples, on the order of one-thousand or more, the diversity of the samples reflects that the sample set is of high quality.

Third, in the creation of training data step, the objective of the process is to create training data demonstrating examples reflecting how an ideal processor would behave under various input conditions. The approach is one of supervised learning, in which samples are submitted to the system for processing then compared to results manually processed by a human expert. The training samples should include both positive and negative examples. Quality and quantity are of utmost importance. If examples are erroneous, this introduces noise in the data used for modeling. Obtaining sufficient training examples for the complete spectrum of patterns seen for a particular logical relation is also important. If the training examples do not include many different patterns that might be encountered in future examples, the classifier can become overtrained in that it will be intensively optimized on a training set distribution that is likely to be different than future test samples. The specialization of the parser/semantic interpreter as a collection of individual logical relation classifiers thus greatly improves the stationary expectation of the underlying individual logical relation probability models Use of a collection of individual classifiers also substantially reduces the size and complexity in terms of the number of independent parameters addressed as compared to one monolithic semantic interpreter classifier.

The human expert working to train the system must indicate all logical relation instances for a particular logical relation class within a sentence. For example, consider the following sentence:

A large mass measuring 5 cm (previously 4.2 cm) is seen.

The instances for the logical relation “hasSize” should include:

hasSize (mass, EQUALS, large)

hasSize (mass, measures, 5 cm)

hasSize (mass, measures, 4.2 cm).

Note that the temporal qualifier “previously” attached to the value 4.2 cm is handled by a separate logical relation classifier, “hasRelativeTime.” Any true instance not indicated will result in the training set being contaminated with false-negative noise. Mislabeled training data will result in the addition of false positive examples infiltrating the training data. In other words, if the system is programmed to think that in two similar word-word dependency examples that both depict the logical relation of interest, one represents the logical relation of interest and one does not, when the latter example is encountered in practice, the system may yield an incorrect result based on the “noise” resulting from this missed example.

The number of training examples required to train the classifier for a given logical relation is related to the number of features associated with that logical relation. In other words, for a fixed sample size, as the number of features is increased, the reliability of the parameter estimates decrease. Consequently, the performance of the resulting classifiers derived from a fixed sample size may degrade with an increase in the number of features associated with the logical relation for which it is responsible. Preferably at least ten times as many training samples per class as the number of features should be used; ideally, one thousand training examples should be used to illustrate each type of logical relation. If, in the subsequent evaluation phase, a classifier works poorly, more training examples should be entered to improve the statistics of the classifier performance.

Fourth, in the statistical model creation step, the objective is the creation of a model that can explain the observed relations manifested in the training examples. The training data for a particular logical relation is stored in a database containing five fields: sentence ID; wordID of head of logical relation; wordID of relation of logical relation; wordID of value of logical relation; and truth, i.e., whether this is a positive example or negative example. These data comprise the data stored for each training sample.

The statistical model built for each type of logical relation focuses on solving a two-category classification problem. Given a logical relation within a sentence is possible, the system must determine the probability that this relation represents a true logical relation in the context of the sentence being processed. The system calculates this likelihood according to this formula:

$$p ( a \vert \vec{b} ) = \frac{1}{Z ( \vec{b} )} \cdot exp \{ {{\sum }^{n}}_{1} {λ}_{i} {f}_{i} ( a , \vec{b} ) \}$$

The likelihood that a true logical relation exists between words is determined by the solution to this probability density function, p(a|b), where “a” classification of whether a particular logical relation exists within a sentence or not and the vector “b” is the context in which the logical relation is seen within a sentence. The estimate of this conditional probability model is obtained from the training data, as described below.

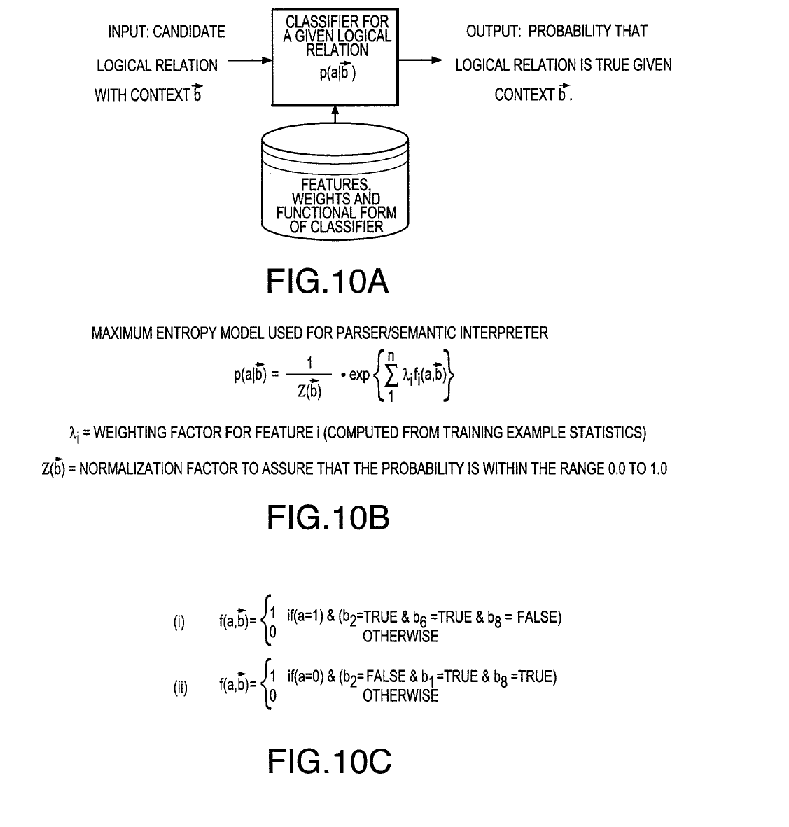

The model construction process starts by defining an appropriate context b that will assist in discriminating between the output states of the classifier. The variable b is a vector that represents the set of features for defining the appropriate context for decision-making. The context for true and positive states of the classifier are expressed in terms of binary-valued feature functions f(a,b). Feature functions can be defined to support both positive discrimination and negative discrimination as shown in FIG. 10C. The features can be any patterns or word states derived from the sentence. Example binary features may include whether the head word of candidate logical relation precedes the value word; whether the value word is the closest value candidate to the head word, whether the value word is before the verb “measuring,” whether the value word is the object of a prepositional phrase with preposition “for,” whether the head word has the semantic class “physicalObject.abnormal.finding,” and whether the value word comes immediately before the head word. Features are custom defined for each logical relation classifier. The specificity of features can be very general to very specific. Features can be overlapping in their constraints and even antagonistic. Examples of general features include word ordering, word distance, and syntactic “valence” preferences.

A word's valence is a standalone property that reflects the word's preference for certain types of word complements. For example, in parts of speech a subject tends to prefer one direct object and not two. A preposition requires both a head and an object. A transitive verb requires an object, whereas an intransitive verb does not. Medium level features deal with semantic associations and ordering between word classes. Specific features may operate at the word or word sequence level. They also include pragmatic features that deal with modeling the real world. For example, only a fluid or gas can have the property of “flow.”

Having defined a set of features for each individual processor to identify a given logical relation type, a maximum entropy probabilistic model is used to integrate the features into a single model in a principled way. FIG. 10B shows the log-linear functional form of the maximum entropy model. This model constrains the estimated distribution to exactly match the expected frequency of features within the training set. Beyond these constraints, the model maximizes the uncertainty so that nothing beyond what is expressed in the training data is assumed. In other words, the maximum entropy algorithm derives a probability distribution p(a|b) that agrees with the empirical distribution of the training data, but is maximally non-committal beyond meeting the observed evidence. Computationally, it is computed using the method of Lagrange Undetermined Multipliers using iterative scaling numerical methods. The maximum entropy model has the properties of assuming nothing that is not observed in the training data, maximizing the likely distribution given the training data and their features, and providing a principled way to combine multiple statistical constraints into a single model. Another desirable feature of maximum entropy is its ability to deal with overlapping and/or conflicting features in a principled way. The model outputs a single probability value, considering the weighted aggregated evidence provided by the context vector b. This probability value is a measure of the “resonance” between a word broadcasting its emission spectrum and a receiver word within the context of the surrounding words of the sentence.

Once appropriate features have been selected and their maximum entropy model weights determined, using the method of Lagrange Undetermined Multipliers and the Generalized Iterative Scaling numeric methods, the model coefficients are stored in the system's database. These coefficients, represented by the lambda-i's in FIG. 10B and typically 10 through 100 in number, are all that is needed to create the statistical classifier for a given type of logical relation.

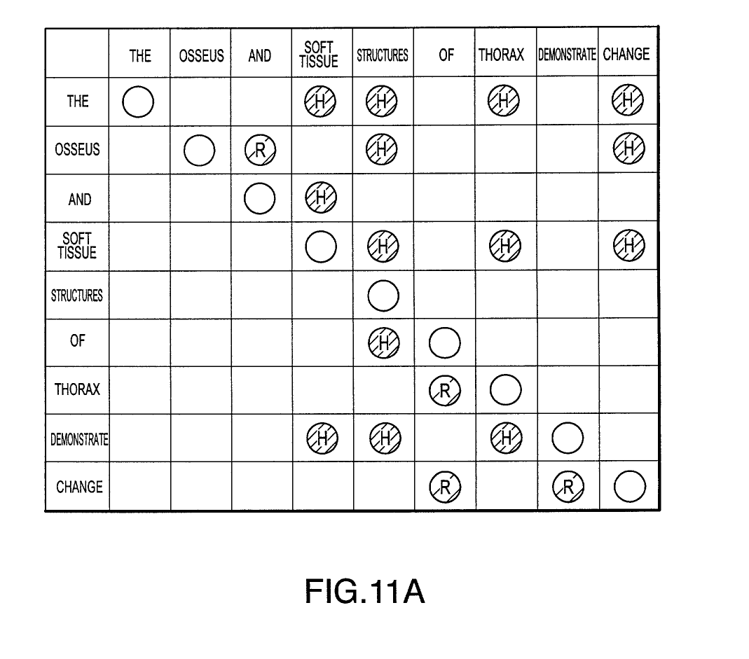

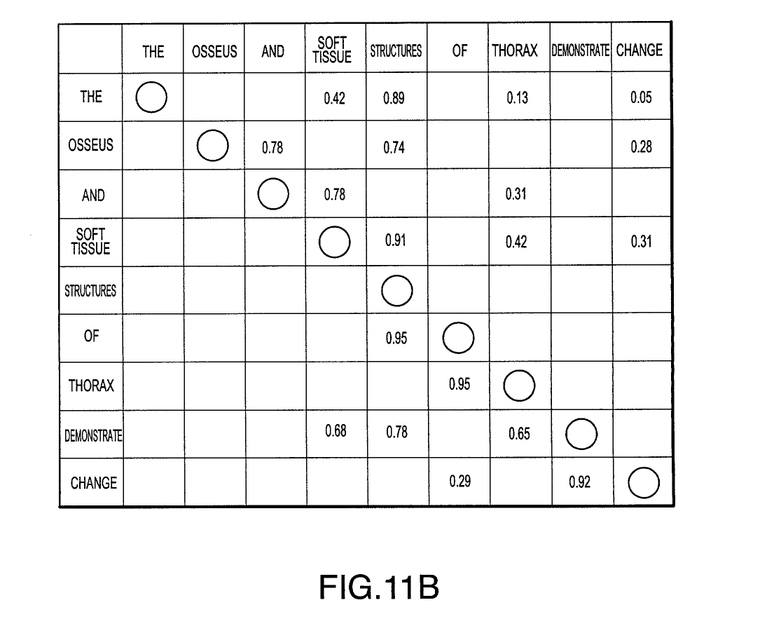

At the conclusion of these steps to build the knowledge base for the parser/semantic interpreter, there is one remaining phase: evaluation of the accuracy of the parser/semantic interpreter as a function of that knowledge base. In a preferred embodiment, a ten-fold cross-validation study design is used for evaluating the accuracy of the current iteration of the system. In this embodiment, the hand tagged examples are randomly assigned to one of 10 data partitions as shown in FIG. 11. One partition is selected to be the test partition, and is blind to all training.

Training and model building is performed using the training examples in the remaining nine partitions. The performance metrics of “Recall” and “Precision” are evaluated on each test set. Recall is the number of correct answers divided by the number of possible answers. Precision is the number of correct answers divided by the number of reported answers.

The process is repeated ten times, with a new test set designated for each iteration. Performance results of the ten iterations of the experiment are then pooled. During the evaluation, each incorrect decision made by the classifier, either a true logical relation classified as false or a false logical relation classified as true, is carefully scrutinized. In this way new positive and negative features can be added and/or new training examples can be added to improve future performance. As described previously, this process is an iterative one; if unsatisfactory results are obtained for one or any number of types of report examples, the system can be further trained on related samples until desirable results are obtained.

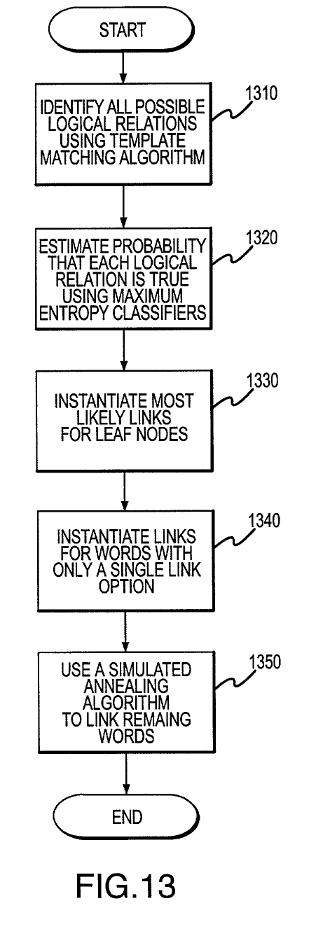

Once the statistical model for the parser/semantic interpreter has been built and the usefulness of its results have been verified, it then can be applied. FIG. 13 depicts the operation of the parser/semantic interpreter. The sentence being analyzed and the results of the lexical analyzer step for each word in the sentence is submitted to the parser/semantic interpreter. The first step in the process involves constructing a “phase space map” to identify all the possible logical relations at 1310. This map provides details of possible allowed states for each word. Specifically, this module identifies possible logical relation instances of interest. Within a sentence, it locates all possible combination of words that can fill the roles within a given logical relation. This step emphasizes high recall over precision. For example, for the processor analyzing the logical relation “hasSize,” the processor determines for every word in the sentence the possibility that each could fulfill any of the syntactic and semantic requirements to serve in the role as a head, relation, or value.

This determination is performed using a template matching method described below. This initial step allows the parser/semantic interpreter step to function as a binary classifier problem which is solved using the maximum entropy models. A template of a possible logical relation is a prototype of the pattern to be recognized. The template itself is automatically constructed from the training data, and represents the identification of word features that match the head, value, and relation of a given logical relation. The pattern includes their relative order, such as whether the head word occurs before or after the value within the sentence order. Thus, for each logical relation, a list of candidate word types is compiled that match the head, relation, and value parameters of the logical relation as shown in Table 1:

TABLE 1
Logical relation template showing the acceptable word classes that can fill
each role.

| Logical | | Lexical Word | Frequency in |
|---|---|---|---|
| Relation Predicate | Role | Feature | Training |
| article (head, EQUALS, | value | article | 200 |
| value) | | | |
| article (head, EQUALS, | head | physobj.* | 102 |
| value) | | | |

Statistics also are accumulated on the frequency of occurrence within the training set of how often a word class is associated with a given logical relation role as head, relation, or value. This model is created to allow for the rapid indexing of the possible logical relations in which each word might be involved. Thus, information is gathered about the probabilistic context-free role of the particle in constructing logical relations. This initial characterization is used as a first pass filter to determine possible candidate logical relations for a given word. Thus the table can be re-analyzed and presented as follows:

TABLE 2
Table 1 reorganized from the perspective of a word class.

| Word | | Word Role | Freq | Freq |
|---|---|---|---|---|
| Class | Logical Relation Member | In LogRel | Yes | No |
| article | article (h, EQUALS, v) | v | 10 | 0 |
| anatomy | Has-perturbation (h, Equals, v) | h | 5 | 25 |
| anatomy | in_location | v | 26 | 7 |

Some degree of deformability is desirable in a template matching algorithm whose goal is high recall. For example, some semantic smoothing can be performed so that individual slot value constraints of the logical relation template are relaxed:

Head->physicalObject.abnormality.finding.lesion.mass->physicalObject.abnormality.finding.lesion

Relative word order may also be relaxed. Note that grammar and context are completely ignored in this preprocessing stage.

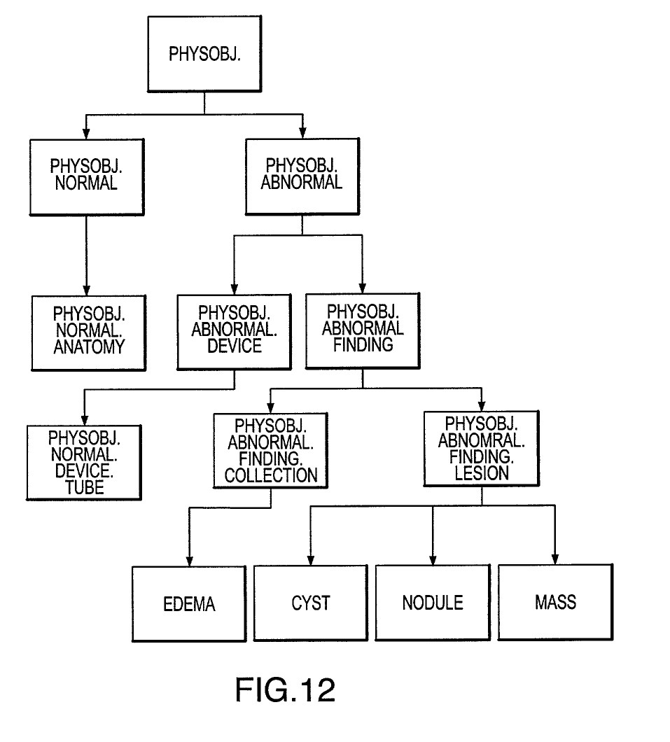

One problem inherent in creating a template matching algorithm automatically from a finite set of training data is that it is unlikely that every combination of words that might be used in a natural language medical report will be addressed. Unforeseen combinations of words will leave gaps in the systems ability to identify all possible logical relation word pairs consisting of heads and values or triplets consisting of heads, relations, and values. To account for this problem, if there is no logical relation slot assignment for a particular words, one will be estimated using a graded relaxation of the syntactic and semantic properties of the word. FIG. 12 illustrates the mechanism used for relaxation. The semantic classes assigned to words is organized into a type abstraction hierarchy. This hierarchy allows a word such as “mass” to be relaxed to the more general abstract class “physobj.abnormal.finding.lesion”. Within this class, the terms “nodule”, and “cyst” are included. In this way, the restrictions of what types of words can fill specific roles of a given logical relation are relaxed. Relaxation can occur as many times as necessary in order to commit each word within the sentence to at least one possible logical relation role.

Because there are hundreds of thousands of words in the English language, therefore it is likely that some words will not have appeared together in sentences in the training corpora and, as a result, there will be no template slot assignments for them. On the other hand, because the number of unique semantic classes is on the order of 500 and the number of syntactic classes is on the order of 15, these numbers are both finite sufficiently small to ensure that at least a default role can be supplied for any unforeseen combination of words. Moreover, of the 500 semantic classes, many of these are parts of hierarchies. For example, “mass” is classified as “physobj.abnorm.finding.lesion,” a class which can be broadened to “physobj.abnorm.finding” or broadened even further to the class of all “physobj.abnorm.” Accordingly, the builders of the database can choose how they might want to balance accuracy and detail in building this concept database.

FIG. 11 shows a phase space map of the possible solutions for the sentence: “The osseus and soft tissue structures of the thorax demonstrate change.” The diagram is interpreted as follows. Along each row i, if a circle with an “H” is present in a column j, that indicates that the word corresponding to row i can possibly link as the value argument to the head word corresponding to row j through some logical relation which is not shown but known in FIG. 11. For example, in row 1 of FIG. 11, the word “the” (row 1) can fill the role of the value of the logical relation “hasArticle” with possible heads “soft tissue” (column 4), “structures” (column 5), “thorax” (column 7) and “change” (column 9). One will note that, intersections where the row number and column number are equal are null possibilities because words cannot modify themselves.

Therefore, for example, the phrase map is equivalent to hypothesizing the following possible uses for the first word “the”:

hasArticle (soft tissue, EQUALS, the)

hasArticle (structures, EQUALS, the)

hasArticle (thorax, EQUALS, the)

hasArticle (change, EQUALS, the)

Note that a dark dot within this matrix merely indicates that the word corresponding to a given row can form a semantically consistent link independent of grammar with the word of the corresponding off-diagonal column. Note that in FIG. 11, there is one word, “structures,” which does not have any possible off-diagonal states. This implies that the system was unable to find any candidate logical relations within the example sentence in which the word “structures” fills the logical relation role of “value.”

Once all possible logical relations have been identified, the maximum entropy classifier corresponding to each logical relation is then applied to determine the probability that each possible logical relation is a true logical relation at 1320 (FIG. 13). The classifier was explained above. This evolves then the phase space map into a map of link probabilities as shown in FIG. 11B.

The map of link probabilities can be seen as a weighted directed graph with the nodes of the graph representing the words within the sentence, and the link probabilities of FIG. 11B representing the edge strength between nodes. This re-formalization now allows the use of existing pairwise clustering algorithms to instantiate the actual links within the sentence at 1330 (FIG. 13).

The actual linking algorithm makes three assumptions. First, the algorithm assumes that each word attaches to only one head with the exception of the head of the sentence (i.e., the subject). Second, the algorithm assumes that crossing arcs are not allowed. Third, the algorithm assumes that circular references are not allowed; for example, if A modifies B, then B cannot modify A. Using these three assumptions and the edge weights assigned using the maximum entropy classifiers as in FIG. 11B, the system uses some standard optimization techniques for determining the final word-pair linkages corresponding to the most likely logical relations for the sentence. In particular, the optimization techniques used are a combination of both a “greedy search algorithm” that simply proceeds in word order to link each word to its most probable head word without violating any of the algorithm's three assumptions, and a simulated annealing algorithm that samples the possible configuration space of the linkages including both a deterministic and probabilistic simulated annealing algorithm. These are fairly standard algorithms.

The initial state of the system is that all words are in a free state in that each word is unattached to any other word. The search for a global optimal attachment configuration for each word begins by first performing an initial noun-phrase and verb-phrase grouping. After this step, the system proceeds by assessing the possible inputs and outputs of each remaining unattached word. As illustrated in FIG. 9A, the number of possible inputs to a word is determined by the number of possible arrows flowing into a word. The number of outputs is the number of arrows flowing out of a word. Words that have no possible inputs but with at least one output are termed “leaf nodes.” In FIG. 9A, the words “The,” “well-demarcated,” “the,” “right,” “8 cm,” “is,” and “again” are all leaf nodes. Leaf nodes are significant because the action of bonding a leaf node to its most likely head does not affect the bonding probabilities of other words that would like to link to it. The bonding of leaf nodes employs linear programming to execute five iterative recursive steps:

1. Find next leaf node and corresponding head node with highest link probability;

2. Instantiate the link;

3. Eliminate any possible links that violate any of the algorithm's three assumptions;

4. Re-estimate all link probabilities;

5. Repeat process.

Once all the leaf nodes have been processed, the system next processes all words with only one possible output at 1340 (FIG. 13). That is, it only has a single bonding option. The exact same five iterative steps is performed for these single option nodes.

Once the leaf nodes and single option nodes have been processed, all remaining nodes, with the exception of the subject of the sentence, find their head words using a standard simulated annealing algorithm at 1350 that can be found in any book on combinatorial optimization. The algorithm efficiently samples through the possible solution space and settles on the combination of links that maximize the overall link probabilities.

There are several advantages to the parser/semantic interpreter of the preferred embodiment of the present invention. First, the system is dominated by statistical methods compared to conventional symbolic rule-based methods. The primary rationale for this approach is adaptability to new domains. Each medical domain has a language model that is different. The language model for radiology is different for pathology, or for discharge reports, etc. For example, the word usage, the stylistic variations in grammar, the communicative goals, and the assumed knowledge between report reader and writer are different in radiology reports as compared to say pathology reports. A language model in one domain my be quite inappropriate if applied to another domain. The knowledge in rule-based systems use hand-coded rules that are implemented using predicate calculus logic. Statistical-based systems create statistical models that rely heavily on inferential/Bayesian logic. Statistical methods aim to automatically learn some, most, or possibly all of the language model from a set of training data.

Second, rule-based systems are more heavily biased by the personality of the developer. The perspective of the developer as to how he writes and what expectations he or she has developed influences the types of rules the developer creates and how the developer dictates conflicts between multiple applicable rules should be resolved. Statistical models derived from many diverse training examples result in a system which objectively resolves this issues based on a range of style and experience not limited or dominated by the preferences of any one person or small group of persons.

Third, because a separate maximum entropy classifier is developed for each type of logical relation, each classifier is more compact and, overall, the system is more accurate. For example, the classifier for extracting the logical relation corresponding to the predicate “hasArticle” is designed separately from that of say the predicate “hasSize.” This allows only features significant for discriminating the existence of these logical relations to be encapsulated within the specific classifier. Additionally, it allows one to easily collect training examples for any defined logical relation using a retrieval engine. Thus, even though the prevalence of “hasArticle” logical relations is much greater than say “hasSize”, one can easily get enough training examples for “hasSize” by simply retrieving over a larger corpus of reports. Thus, even for fairly infrequent types of logical relations, such as “hasShape,” one can assemble a large number of training data. Moreover, the training data for a given logical relation requires only tagging logical relation instances of the given type within a training sentence and no others, saving programmer time.

Fourth, scaling to new domains in rule-based system is more labor intensive because of the necessity of adding new rules, deleting some old ones and/or resolving and understanding differences in language models. Statistics-based systems relearn the applicability of a language model from new training examples within the domain.

Finally, rule-based methods are more fragile because the only symbolic relations possible are “equal to” and “not equal to” Statistical methods can provide answers to contexts that have never been encountered based on partial statistics.

Once the parser/semantic interpreter has completed its operations for the given report, it is a relatively simple matter for a frame generator at 650 (FIG. 6) to assemble the resulting set of structured logical relations into resulting structured data frames 660. Again, based on the identified disease signature, the system expects certain types of records to be created, each containing certain types of fields.

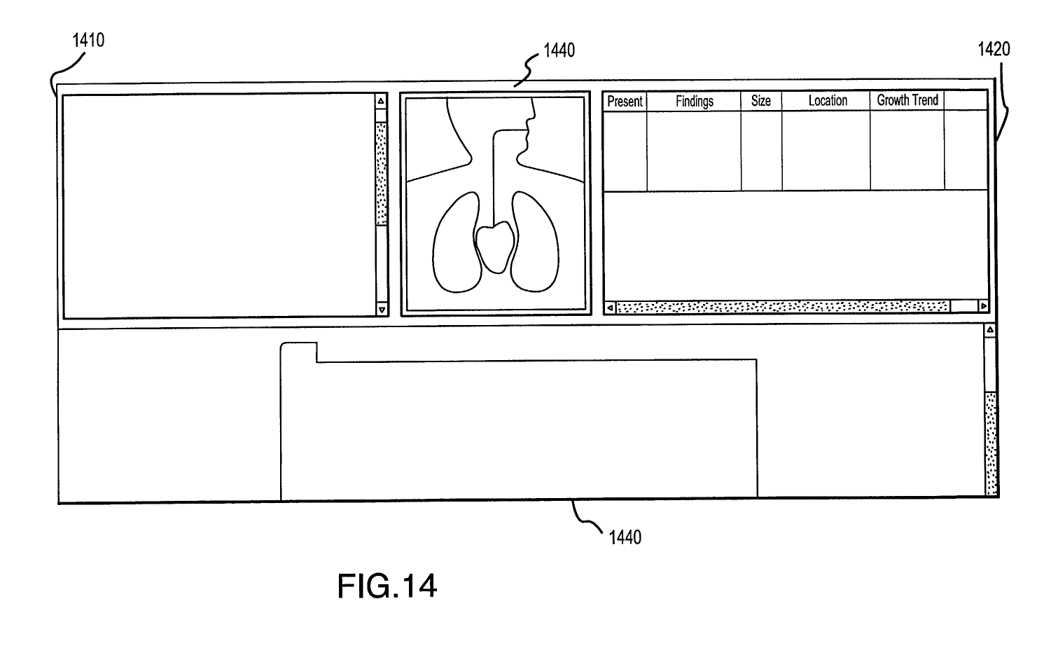

At this step in the process, in the preferred embodiment the medical professional or his qualified assistant would be given an opportunity to review and or edit the relationships assigned by the semantic interpreter and frame generator. In the preferred embodiment, a graphically-based system would present the reporting medical professional with a screen displaying multiple windows to facilitate his or her review of the relationships assigned, as shown in FIG. 14. A text window 1410 displays the report language on which the analysis was based to give the professional a reference for the source of the relationships being assigned. A relation window 1420 shows in a structured list the nature of the finding and the attributes assigned fields to show the language submitted. Also, to more visually display the findings identified and the characteristics identified by the frame generator, ideally a schematic window 1430 would display the finding to very plainly confirm what the system has derived from the report. The schematic window 1430, as with the other aspects of the system, is tailored to the disease signature originally identified. Accordingly, because the sample reported discussed in the disclosure of the present invention concerns thoracic radiology, a schematic of a chest X-ray is used to visually represent the system's analysis. Finally, an edit/entry window 1440 gives the medical professional means with which to correct any errors made by the parser/semantic interpreter's assessment, supply data missing from the original report, or otherwise edit the resultant structured report. Ideally, the medical professional could highlight the finding at issue in the relation window 1420, and the edit/entry window would then present the different fields in that entry for editing.

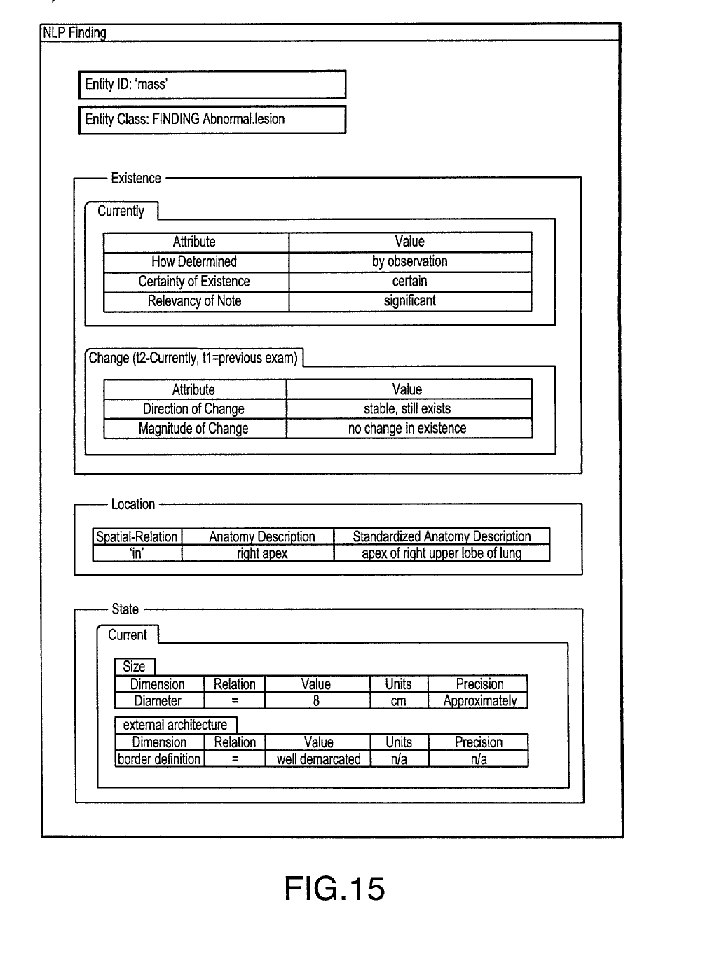

As shown in FIG. 15, one frame generated will be a record for the medical professional's finding or findings. For the finding of a “mass,” just as the semantic interpreter was preprogrammed to inspect for certain modifiers, the frame generator is preprogrammed to generate fields for those modifiers. As shown in FIG. 15, for a finding of a “mass,” the frame generator is preprogrammed to include fields for the size, number of, location, and trend of the mass. In turn, the frame generator includes subfields for location, direction, part of, and further direction to identify the precise location of the mass. Similarly, for the trend, the frame generator is preprogrammed to include fields to identify the property of the trend. Once the frames are generated, they necessarily will be linked so that a researcher finding and interested in the record on this particular “mass” can review related records to allow the researcher to learn more about the patient's characteristics and history, the physician, the course of treatment, and other related findings.

The benefits of the existence of these structured records is clear. Merely accumulating all the natural language reports will result in a conflagration of potentially useless information. As previously described, words can have vastly different meanings in different medical contexts, such as for the example of the word “dilation,” and words can have different meanings in different sentences in the same report, such as for the example of the word “increased.” A simple textual query of the universe of medical information for someone who was interested in learning about masses of increasing size in the upper right lobe might retrieve a number of strange returns based on the coincidental use of these words. Alternatively, the researcher might not locate the relevant records. For example, if the researcher entered a query searching literally for “increased large mass,” the researcher would not find the sample report described here because those words were not entered in the medical professional's natural language report in that sequence.

On the other hand, with the structured data generated by the system, a researcher interested in learning about such masses could enter his or her query in a structured form identifying that the finding of interest is a “mass,” having a “large” size, and that has a trend of having “increased” in size. A computing system could then, as computer systems are very well-suited to do, hierarchically search the database for findings of masses, then narrow the search to those that are large and increasing in size. Ultimately, therefore, the method and system of the present invention greatly enhance the utility of the information contained in medical professionals' examination reports.

It is to be understood that, even though various embodiments and advantages of the present invention have been set forth in the foregoing description, the above disclosure is illustrative only. Changes may be made in detail, and yet remain within the broad principles of the invention.

1. A method for translating a report generated in natural language into structured computer-understandable frames comprising:
eliciting directed input as to a medical condition and symptoms;
using the directed input elicited to identify a disease signature corresponding to the medical condition and symptoms;
using the disease signature to identify a lexical domain containing language information pertinent to the disease signature, the lexical domain having been programmed with word properties for words expected to be used with regard to the disease signature, the word properties including a likelihood that combinations of words in the lexical domain interdepend and each word's inherent tendency to link with other words;
looking up the word properties for words used in the report in the lexical domain;
calculating for combinations of words used in sentences contained in the report a statistical likelihood that they interdepend and identifying probable word links;
semantically interpreting a nature of the probable word links; and
generating the structured computer-understandable frames based on the nature of the probable word links.

2. The method of claim 9 further comprising structurally analyzing the report to delineate between the sections of the report and between separate sentences.

3. The method of claim 9 wherein the word properties include the syntactic properties of each word.

4. The method of claim 9 wherein the word properties include the semantic properties of each word.

5. The method of claim 9 wherein the word properties include both the syntactic and semantic properties of each word.

6. The method of claim 9 wherein the likelihood of that combinations of words in the lexical domain interdepend is based on empirical statistics on how frequently the combinations of words in the lexical domain have interdepended in preexisting reports.

7. The method of claim 9 wherein the inherent tendency of each word to link with other words is based on empirical statistics of how frequently that word interacts with other words and with what types of other words.

8. The method of claim 9 wherein, for novel combinations of individual words not stored in the lexical domain, the likelihood that the novel word combination interdepends is estimated based on syntactic and semantic properties of the individual words.

9. A method for translating a report about a patient, afflicted with a medical condition and symptoms, generated in natural language into structured computer-understandable frames comprising:
identifying a disease signature corresponding to the medical condition and symptoms;
using the disease signature to identify a lexical domain containing language information pertinent to the disease signature, the lexical domain having been programmed with word properties for words expected to be used with regard to the disease signature, the word properties including a likelihood that combinations of words in the lexical domain interdepend and each word's inherent tendency to link with other words;
looking up the word properties for words used in the report in the lexical domain;
calculating for combinations of words used in sentences contained in the report a statistical likelihood that they interdepend and identifying probable word links;
semantically interpreting a nature of the probable word links; and
generating the structured computer-understandable frames based on the nature of the probable word links.

10. The method of claim 9 further comprising structurally analyzing the report to delineate between the sections of the report and between separate sentences.

11. The method of claim 9 wherein the word properties include the syntactic properties of each word.

12. The method of claim 9 wherein the word properties include the semantic properties of each word.

13. The method of claim 9 wherein the word properties include both the syntactic and semantic properties of each word.

14. The method of claim 9 wherein the likelihood of that combinations of words in the lexical domain interdepend is based on empirical statistics on how frequently the combinations of words in the lexical domain have interdepended in preexisting reports.

15. The method of claim 9 wherein the inherent tendency of each word to link with other words is based on empirical statistics of how frequently that word interacts with other words and with what types of other words.

16. The method of claim 9 wherein, for novel combinations of individual words not stored in the lexical domain, the likelihood that the novel word combination interdepends is estimated based on syntactic and semantic properties of the individual words.

17. A system for translating a report generated in natural language into structured computer-understandable frames comprising:
a patient input module that elicits from a patient directed input as to the patient's medical condition and symptoms and, based on the patient directed input, identifies a disease signature corresponding the patient's medical condition and symptoms;
a lexical analyzer using a lexical domain containing language information pertinent to the disease signature, the lexical domain having been programmed with word properties for words expected to be used with regard to the disease signature, the word properties including a likelihood that combinations of words in the lexical domain interdepend and each word's inherent tendency to link with other words, and the lexical analyzer looks up the word properties for words used in the report in the lexical domain;
a parser/semantic interpreter module for calculating for combinations of words used in sentences contained in the report a statistical likelihood that they interdepend and identifying probable word links; and
a structured frame generator that creates the structured computer-understandable frames based on the nature of the probable word links.

18. The system of claim 17 further comprising a structural analyzer to delineate the report into sections and delineate between separate sentences.

19. The system of claim 17 wherein the word properties include the syntactic properties of each word.

20. The system of claim 17 wherein the word properties include the semantic properties of each word.

21. The system of claim 17 wherein the word properties include both the syntactic and semantic properties of each word.

22. The system of claim 17 wherein the likelihood of that combinations of words in the lexical domain interdepend is based on empirical statistics on how frequently the combinations of words in the lexical domain have interdepended in preexisting reports.

23. The system of claim 17 wherein the inherent tendency of each word to link with other words is based on empirical statistics of how frequently that word interacts with other words and with what types of other words.

24. The system of claim 17 wherein, for novel combinations of individual words not stored in the lexical domain, the likelihood that the novel word combination interdepends is estimated based on syntactic and semantic properties of the individual words.

25. A system for translating a report about a patient, afflicted with a medical condition and symptoms, generated in natural language into structured computer-understandable frames comprising:
a disease signature identifier which identifies a disease from which the patient is suffering corresponding to the patient's medical condition and symptoms;
a lexical analyzer using a lexical domain containing language information pertinent to the disease signature, the lexical domain having been programmed with word properties for words expected to be used with regard to the disease signature, and the lexical analyzer looks up the word properties for words used in the report in the lexical domain;
a parser/semantic interpreter for calculating for combinations of words used in sentences contained in the report a statistical likelihood that they interdepend and identifying probable word links; and
a structured frame generator that creates the structured computer-understandable frames based on the nature of the probable word links.

26. The system of claim 25 further comprising a structural analyzer to delineate the report into sections and delineate between separate sentences.

27. The system of claim 25 wherein the word properties include the syntactic properties of each word.

28. The system of claim 25 wherein the word properties include the semantic properties of each word.

29. The system of claim 25 wherein the word properties include both the syntactic and semantic properties of each word.

30. The system of claim 25 wherein the likelihood of that combinations of words in the lexical domain interdepend is based on empirical statistics on how frequently the combinations of words in the lexical domain have interdepended in preexisting reports.

31. The system of claim 25 wherein the inherent tendency of each word to link with other words is based on empirical statistics of how frequently that word interacts with other words and with what types of other words.

32. The system of claim 25 wherein, for novel combinations of individual words not stored in the lexical domain, the likelihood that the novel word combination interdepends is estimated based on syntactic and semantic properties of the individual words.
